(19) United States
(12) Patent Application Publication
(10) Pub. No.: US 2006/0094633 A1
(43) Pub. Date: May 4, 2006

(54) Effervescent tablet comprising a colorant

(76) Inventor: Jan Overwater, De Kwakel (NL)

Correspondence Address: TRASK BRITT, P.O. BOX 2550, SALT LAKE CITY, UT, 84110, US

(21) Appl. No.: 11/076,413

(22) Filed: Mar. 9, 2005

(30) Foreign Application Priority Data
Nov. 4, 2004 (EP) EP 04105531.0

(51) Int. Cl. C11D 17/00

(52) U.S. Cl. 510/446; 510/447

(57) ABSTRACT

An effervescent tablet includes an organic acid, an alkali metal or earth alkali metal hydrogen carbonate, and a colorant for decorative use is disclosed. The tablet may also include at least one of an aromatic substance and a nutrient for plants or flowers. The tablet may be added to water to give color to water, such as water for cut flowers. A combination of such a tablet and cut flowers is also disclosed.

### CROSS-REFERENCE TO RELATED APPLICATION

This application claims the benefit of priority under 35 U.S.C. § 119 to prior European patent application EP 04105531.0, filed on Nov. 4, 2004, the disclosure of which is hereby incorporated by this reference as if set forth in its entirety herein.

### BACKGROUND OF THE INVENTION

1. Field of the Invention

The invention relates to an effervescent tablet comprising a colorant. More particularly, the invention relates to a method for giving color to water which is used for cut flowers. The invention also pertains to a combination of cut flowers and said tablet.

2. Background of Related Art

Effervescent tablets as such are known. For instance in British patent application GB 1075470 effervescent tablets which contain at least one test reagent or diagnostic agent to be dispersed in an aqueous liquid comprise a core and at least one covering layer, each containing a water-soluble dye is described. This relates to test reagent or diagnostic agent is therefore related to a completely different field and use.

In FR 2628734 soluble fertilizers in tablet form are disclosed, containing nutrient materials and an effervescence agent, so that the tablet bubbles and dissolves in water. The tablets may also contain a dye, to give an instant indication that the fertilizer has been added to the water. These tablets thus service another purpose, i.e. not decorative but are used as an indicator for giving a measured amount of fertilizing material to a garden.

In CA 2122873 an effervescent tablet is formed which contains a carbonate, an organic acid, at least one dye, a solubilizing agent, and a binder. The tablet, which is non-toxic, can be dissolved in water, so that a dye is released which can be used to dye Easter eggs. Also this tablet serves a different purpose and is used in a different field.

The closest prior art is British patent application GB 1442979 disclosing a composition for keeping flowers fresh, which composition is in the form of an effervescent tablet which comprises nutrient for keeping flowers fresh. These tablets do not contain colorants or dyes.

Accordingly, there are needs for methods and compositions for giving a color to water for decorative purposes, and more particularly for giving a color to water for cut flowers and, optionally, nutrients to water for cut flowers or odor to the environment.

### SUMMARY OF THE INVENTION

In its broadest concept the invention relates to an effervescent tablet comprising an organic acid, an alkali metal or earth alkali metal hydrogen carbonate, and a colorant for decorative use. More particularly, the invention relates to such tablets further comprising at least one of an aromatic substance and nutrient for plants or flowers.

The invention further provides a method of giving a color to water, for instance water in a bowl or the like. More particularly, the water is water for flowers, such as water in a vase. It is further commercially attractive to provide a combination of cut flowers and a tablet of the invention which can be used as such by the consumer. The tablet may for that purpose be attached to a label that can be provided together with the flowers or plant.

### DETAILED DESCRIPTION

The effervescent tablet may be any effervescent tablet that is known in the art and that dissolves sufficiently fast. The production of effervescent tablets from, for instance, bicarbonates and solid organic carboxylic acids is known but not in combination with the other components mentioned above with the purpose of providing a composition for giving water for flowers a color. Further advantages are the easy handling and, as a result of the effervescent effect, the ability to dissolve rapidly, as well as a good mixing and thus a rapid effectiveness of the active components of the effervescent tablet composition according to the present invention. The tablet may be coated, for instance with a cellulose derivative such as hydroxypropyl methylcellulose. Coated tablets have the advantage that they prevent preliminary release of the colorant and further improve the resistance against humidity.

The following ingredients are mentioned as example only and should not be interpreted restrictively.

A suitable composition for the tablet of the invention may comprise one or more of the following components (expressed in wt.% based on the total weight of the mixture):
Optionally, a plant nutrient, for instance a sugar such as glucose and/or dextrose, in an amount of 0 to 96 wt. %, preferably 35 to 75 wt. %;
Optionally, a surfactant, preferably in an amount of 1 to 4 wt. %;
Optionally, a bactericide for inhibiting or killing bacteria in the water for the flowers, preferably in an amount of 1 to 5 wt. %;
An organic carboxylic acid, preferably an organic dicarboxylic acid such as for instance succinic acid or tartaric acid, preferably in an amount of 5 to 40 wt. %, more preferably 10 to 26 wt. %;
An alkali metal or earth alkali metal hydrogen carbonate, preferably 6 to 40 wt. %, more preferably 15 to 30 wt. %. The alkali metal, particularly sodium or potassium, hydrogen carbonates are preferred.

The above mixture can be varied but at least contains the organic carboxylic acid, the hydrogen carbonate and the colorant. This mixture forms the basis for making an effervescent tablet that is suitable for giving a color to water.

The organic carboxylic acid may be in its anhydrous form. It was found that the use of anhydrous organic carboxylic acids substantially increases the stability of the effervescent tablet. Such tablets are not hygroscopic and can be stored and sold without the need for special water-impermeable packaging. Suitable anhydrous organic carboxylic acids include, but are not restricted to, citric acid, oxalic acid, pyruvic acid, malic acid, malonic acid, succinic acid, glutaric acid, adipic acid, gluconic acid, lactic acid, tartaric acid, and mixtures thereof. Organic dicarboxylic acids are more preferred, and most preferred are anhydrous hydroxy dicarboxylic acids such as anhydrous tartaric acid.

The mixture may further comprise a thickening agent such as polyethylene glycol (for instance PEG 6000, Na stearyl fumarate, and the like) for preventing sticking.

The nutrient may be any common nutrient for use in flowers and plants, and usually contain a sugar or a mixture of sugars, such as glucose, dextrose, and the like.

The mixture may contain common bactericides and fungicides such as quaternary ammonium compound, containing an alkyl radical, for example, one of the following Barquat® MS-100 (myristyl dimethyl benzyl ammonium chloride dihydrate), Bardac® 22 (didecyl dimethyl ammonium chloride), Bardac® 20 (a mixture of 50% by weight octyl decyl dimethyl ammonium chloride; 25% by weight dioctyl dimethyl ammonium chloride and 25% by weight didecyl dimethyl ammonium chloride).

The tablet further includes a colorant. The colorant may be any colorant that does not harm the flowers. In principle almost any colorant can be used in quantities sufficient to give the desired color intensity. Suitable amounts are 0.1 to 10 wt. %, more preferably 0.5 to 5 wt. %. Suitable colorants include, but are not limited to, ecoline pigments, food pigments (E dyes), acid pigments, metal complex acid dyes, basic dyes, chrome dyes, disperse dyes, solvent dyes, direct dyes, phthalates fast dyes, naphthol dyes, reactive dyes, such as pigment emulsion dyes, fast color salts dyes, rapid fast dyes, aluminum lake color (pigments) wet dyes, natural dyes, and the like.

The tablet may contain other components such as potassium chloride (1 to 5 wt. %), aluminum sulfate (1 to 5 wt. %), and the like.

The tablet may contain aromatic compounds such as ethereal oils, hesperides, air fresher, and the like, such as for instance the oils rose Sonia, rose Tros, freesia, carnation, lily-of-the-valley, lilac, floral bouquet, sweet freesia, rose fruity, banana sweet, and cinnamon.

In a specific example according to the invention the following mixture for an effervescent tablet was made:

| | | |
|---|---|---|
| Flower Food Clear ® (Plant nutrient mix) | 56 | wt. % |
| tartaric acid | 14.8 | wt. % |
| NaHCO₃ | 26.3 | wt. % |
| PEG 6000 | 2.9 | wt. % |

To this mixture 1 wt. % of Tartrazine E-120 (a colorant) based on the weight of the mixture was added, i.e. to 495 grams of above mixture 5 grams of colorant were added.

Although the foregoing description contains many specifics, these should not be construed as limiting the scope of the present invention, but merely as providing illustrations of some of the presently preferred embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

1. An effervescent tablet comprising an organic acid, an alkali metal or earth alkali metal hydrogen carbonate, and a colorant for decorative use.

2. The tablet of claim 1, wherein the organic acid is anhydrous.

3. The tablet of claim 2, further comprising at least one of an aromatic substance and nutrient for plants or flowers.

4. The tablet of claim 1, further comprising at least one of an aromatic substance and nutrient for plants or flowers.

5. A method for giving color to water for use with cut flowers by adding a tablet comprising an organic acid, an alkali metal or earth alkali metal hydrogen carbonate, and a colorant to the water.

6. The method of claim 5, wherein adding the tablet comprises adding to the water a tablet in which the organic acid is anhydrous.

7. The method of claim 6, wherein adding the tablet comprises adding to the water a tablet further comprising at least one of an aromatic substance and a nutrient for plants or flowers.

8. The method of claim 5, wherein adding the tablet comprises adding to the water a tablet further comprising at least one of an aromatic substance and a nutrient for plants or flowers.

9. In combination, cut flowers and an effervescent tablet comprising an organic acid, an alkali metal or earth alkali metal hydrogen carbonate, and a colorant for decorative use.

10. The combination of claim 9, wherein the organic acid of the effervescent tablet is anhydrous.

11. The combination of claim 10, wherein the effervescent tablet further comprises at least one of an aromatic substance and nutrient for plants or flowers.

12. The combination of claim 9, wherein the effervescent tablet further comprises at least one of an aromatic substance and nutrient for plants or flowers.
